(19) United States
(12) Patent Application Publication
(10) Pub. No.: US 2004/0185408 A1
(43) Pub. Date: Sep. 23, 2004

(54) Cooling grid for a bulk material cooling device

(76) Inventors: Thomas Staak, Hamburg (DE); Ulrich Suer, Rehburg (DE); Archibald Wallace, Hamburg (DE)

Correspondence Address: MORRISON & FOERSTER LLP, 1650 TYSONS BOULEVARD, SUITE 300, MCLEAN, VA, 22102, US

(21) Appl. No.: 10/474,023

(22) PCT Filed: Apr. 5, 2002
(86) PCT No.: PCT/EP02/03805

(30) Foreign Application Priority Data
Apr. 6, 2001 (DE) 101 17 225.7

(51) Int. Cl. F27D 15/02

(52) U.S. Cl. 432/77; 110/264

(57) ABSTRACT

A cooling grate for a bulk-material cooler, in particular for combustion material (8) such as cement clinker, of which the top side forms a carrying surface which supports the combustion material (8) which is to be cooled, the cooling grate (1) being made up of a plurality of fixed shaped profiles (4) which partially engage one over the other and between which gas-throughflow channels (5) are formed, it being the case that the shaped profiles (4) are of the same shape and have a central part (41) and outer parts (42, 43) which are angled in opposite directions to the central part (41), the shaped profiles (4) being arranged such that in each case one of the gas-throughflow channels (5) is formed between in each case one of the outer parts (42′, 43) of two directly adjacent shaped profiles (4, 4′). There is preferably provided a support (3) which has position-defining mounts (36) for the shaped profiles (4).

The invention relates to a cooling grate for a bulk-material cooler, in particular for combustion material such as cement clinker, of which the top side forms a carrying surface which supports the material for cooling, the cooling grate being made up of a plurality of fixed shaped profiles which partially engage one over the other and between which gas-throughflow channels are formed.

Cooling grates of this type serve for accommodating and for cooling combustion material which is fed to the cooler. For this purpose, the cooling grate has to perform essentially three functions, namely those of bearing the combustion material which is to be cooled, of providing means for feeding the cooling gas and of forming a basis for a conveying system for the combustion material which is to be cooled. The conveying system ensures that the combustion material is transported via the fixed cooling grate.

Such a cooler is known from EP-B-0 676 031. This document describes a cooling grate made up of a plurality of shaped profiles. Use is made of two different types of shaped profiles. The first type is configured as a cross-sectionally essentially rectangular bar of which the underside has a central depression which extends in the longitudinal direction. The second type of shaped profiles is in the form of an upside-down T in cross section, the transverse parts of the T being provided at their free ends in each case with a border which extends in the direction of the longitudinal part of the T. The two types of shaped profiles are arranged alternately. In this case, the borders on the transverse parts of the two directly adjacent T-like shaped profiles engage in the depression of one of the rectangular shaped profiles. This results in a gas-throughflow channel being produced between in each case one rectangular shaped profile and one T-like shaped profile. The channel, rather than being rectilinear, has a plurality of deflections in order to prevent material from falling through. The disadvantage with the known cooling grate is that the shaped profiles with their depressions and their borders involve high outlay to produce and are also fairly difficult to assemble. In addition, two different types of shaped profiles are necessary, as a result of which the necessary outlay is further increased.

A cooling grate of a different generic type is described in DE-A-195 37 904. This cooling grate is formed from a variety of shaped profiles which are joined together such that they butt closely against one another by way of their longitudinal sides. On their longitudinal sides which are intended for butting against adjacent shaped profiles, the shaped profiles have groove-like recesses which run obliquely from the under-side to the top side. In the joined-together state, these groove-like recesses form gas-throughflow channels from the underside of the cooling grate in the direction of the top side thereof. The disadvantage here is that the shaped profiles with their recesses involve high outlay to produce. This is all the more so the case because a dedicated recess is necessary for each individual gas-throughflow channel. A multiplicity of gas-throughflow channels are necessary for a good, uniform cooling result, this giving rise to considerable outlay.

It is also known for the cooling grate to be made up of a plurality of profiles which are of U-shaped configuration or of U-shaped and T-shaped configuration and are arranged alternately. Such cooling grates involve high outlay to produce and assemble.

Also known in addition to the cooler construction described above is a further cooler construction in the case of which the grate, which bears the combustion material to be cooled, and the conveying system for transporting the combustion material via the cooler are not designed separately from one another. In this case, instead of the fixed cooling grate, use is made of a movable push grate. The push grate comprises a plurality of rows which are alternately arranged in a fixed and movable manner. The movable rows are moved back and forth by means of a drive device. By virtue of the reciprocating movement, the combustion material which is to be cooled is transported along the push grate. The rows of the push grate are often constructed from a plurality of plate elements (WO 99/44001, U.S. Pat. No. 5,174,747). On account of the movable rows, push grates involve high outlay to produce and to operate.

Taking the cooling grate described in EP-B-0 676 031 as the departure point, the object of the invention is to provide a cooling grate of the type mentioned in the introduction which reduces the abovementioned disadvantages.

The solution according to the invention resides in a cooling grate having the features of claim 1. Accordingly, in the case of a cooling grate for a cooler for combustion material such as cement clinker, of which the top side forms a carrying surface which supports the combustion material which is to be cooled, the cooling grate being made up of a plurality of fixed shaped profiles which engage partially one over the other and between which gas-throughflow channels are formed, it is provided that the shaped profiles are of the same shape and have a central part and outer parts which are angled in opposite directions to the central part, the shaped profiles being arranged such that in each case one of the gas-throughflow channels is formed between in each case one of the outer parts of two directly adjacent shaped profiles.

Angled in opposite directions is understood here as meaning that, in relation to the central part, one of the outer parts is angled in the direction of one side of the central part, while another outer part is angled in the direction of the opposite side of the central part. The outer parts are thus oriented in opposite directions, it not being necessary for them to be oriented in precisely opposite directions, that is to say to be offset by 180° in relation to one another.

The invention has found that, using the configuration of the shaped profiles according to the invention, it is possible to avoid the considerable outlay which is brought about by using two shaped profiles of different shapes. The cooling grate according to the invention is thus easier to produce and also more favorable to maintain. Moreover, it is easy to assemble since the shaped profiles engage one over the other in the manner of roofing tiles and can thus easily be positioned one after the other. These advantages are not at the cost of an impaired cooling result; rather, the cooling grate according to the invention even provides a more favorable configuration of the gas-throughflow channels. Since, in the case of the cooling grate according to the invention, the gas-throughflow channel is formed merely by two outer parts of adjacent shaped profiles which are located opposite one another, the gas-throughflow channel, in comparison with the generically determinative, known cooling grate, is shorter and has fewer deflections for the gas stream. This reduces to a considerable extent the resistance which counteracts the gas stream, as a result of which it is possible either to increase the quantity of the cooling-gas stream or to provide the cooling-gas supply device with smaller dimensions. Fewer deflections in the gas-throughflow channel also mean less vortexing, as a result of which the uniformity of the cooling-gas action to which the combustion material which is to be cooled is subjected is increased.

The outer parts are expediently arranged parallel to one another in the region of the gas-throughflow channel. This has the advantage that the gas-throughflow channel has a constant width between the two parallel outer parts. Constrictions with their disadvantages in respect of an increase in resistance and vortex formation are thus avoided. This results in a better and more uniform distribution of the cooling gas.

The outer parts are advantageously arranged such that the gas-throughflow channel formed by them provides outgoing cooling gas with a direction component parallel to the plane of the cooling grate. Such a cooling-gas stream which is also directed in the cooling-grate plane makes it possible to achieve more uniform cooling since, in this way, more cooling gas passes into the regions of the combustion material between the gas-throughflow channels. Furthermore, such an arrangement reduces the risk of combustion material penetrating into, and falling through, the gas-throughflow channels.

It is advantageous if the shaped profile is designed with rounded angles. A rounded configuration of the angles between the central part and the outer parts has the advantage that the cooling gas, as it enters into the gas-throughflow channel, can pass the transition region between the central part and the outer part more smoothly. This also avoids the formation of vortices and aids uniform guidance and thus distribution of the cooling gas.

The shaped profile is expediently of Z-shaped design. Such a configuration of the shaped profile has the advantage of particularly straightforward production and assembly of the shaped profiles to form a cooling grate. The gas-throughflow channel formed between two outer parts of adjacent shaped profiles is also favorable in terms of flow in the case of a Z-shaped design of the shaped profiles since, with the exception of the inlet and outlet regions, there is no deflection of the gas stream within the gas-throughflow channel; rather, the cooling gas can flow straight ahead. Z-shaped is not just understood here as meaning that the outer parts are arranged at an acute angle in relation to the central part; rather, they may also advantageously be arranged at right angles or even at an obtuse angle.

Although it is advantageous if the central part and/or the outer parts is/are of flat design, this is not absolutely necessary. They may also be of curved design. The latter even has the advantage that the transitions between the central part and outer part can run more smoothly, as a result of which the gas-throughflow channel sets less resistance against the cooling-gas stream.

In the case of a particularly advantageous configuration, the shaped profiles are centrally symmetrical. This results in the advantage that assembly of the shaped profiles to form the cooling grate is further simplified since it is immaterial whether or not they are fitted in a state in which they have been turned 180° the wrong way. Mix-ups during assembly are thus more or less ruled out.

The shaped profiles are expediently arranged transversely in relation to the conveying direction of the combustion material which is to be cooled. On the one hand, this achieves a favorable arrangement of the gas-throughflow channels; on the other hand, and in particular, however, the combustion material is subjected to a greater braking action.

It is particularly expedient if there is provided a support which has position-defining mounts for the shaped profiles. The mounts allow easy and precisely positioned assembly of the shaped profiles on the supports. This applies, in particular, when the angle position and longitudinal position are determined by the mounts.

The invention is explained hereinbelow with reference to the attached drawing, which illustrates advantageous exemplary embodiments of the invention and in which:

FIG. 1 shows a sectional view of a cooling grate according to a first exemplary embodiment of the invention;

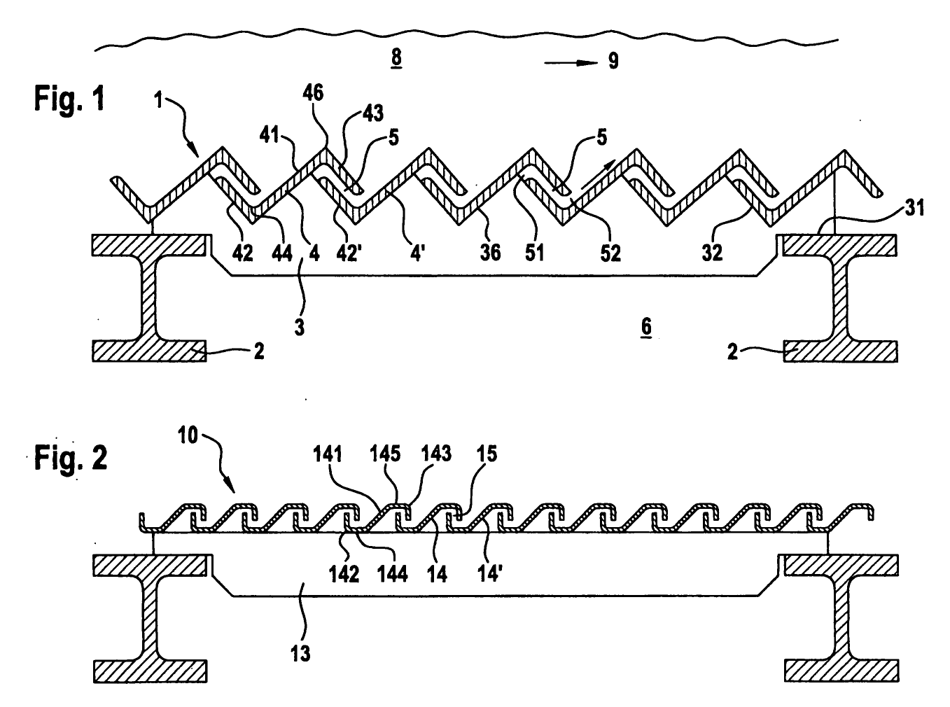

FIG. 2 shows a sectional view of a cooling grate according to a second exemplary embodiment of the invention;

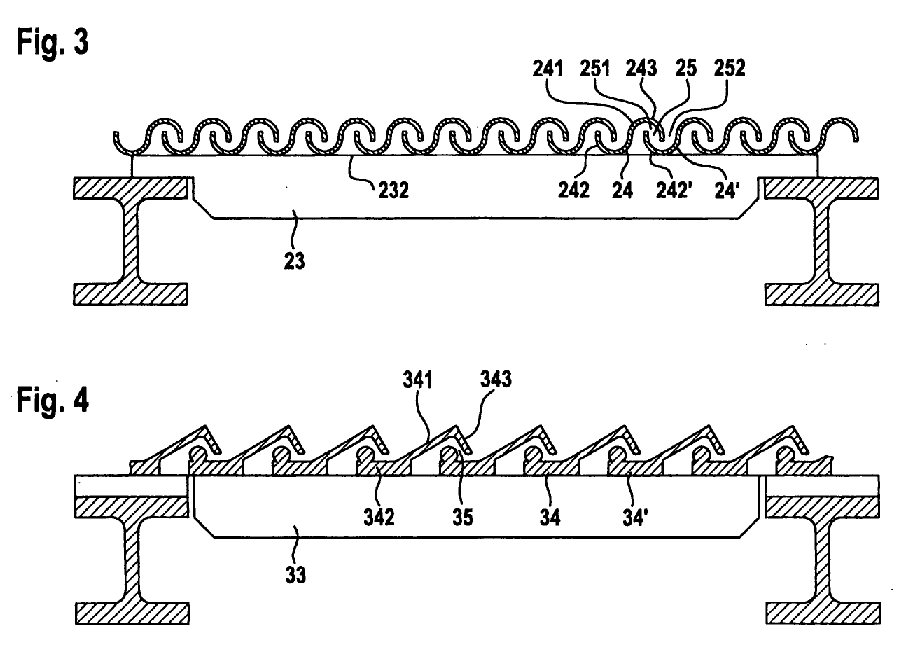

FIG. 3 shows a sectional view of a cooling grate according to a third exemplary embodiment of the invention; and

FIG. 4 shows a sectional view of a cooling grate according to a fourth exemplary embodiment of the invention.

It should be assumed, for the sake of simplicity, that all the exemplary embodiments described hereinbelow relate to a cooling grate for a cooler which has cooling gas flowing through it from bottom to top and, in the process, serves for cooling hot material, in particular hot cement clinker and the like.

A first exemplary embodiment of the cooling grate according to the invention will be explained with reference to FIG. 1. A cooler contains a cooling grate 1, on which combustion material 8 which is to be cooled rests and is transported in a conveying direction 9 by a conveying mechanism (not illustrated). Formed beneath the cooling grate 1 is a plenum 6, which is fed cooling gas from a cooling-gas supply device (not illustrated) in order, finally, for the cooling gas to be fed, through the cooling grate 1, to the combustion material 8 for cooling purposes.

The cooling grate 1 is arranged on two main I-shaped supports 2 which run transversely to the conveying direction 9. For the sake of simplicity, merely two of these main supports 2 have been illustrated, but it is also possible to provide any desired number of main supports 2. Longitudinal supports 3 are arranged transversely to the main supports 2, and thus parallel to the conveying direction 9. At their ends, they have recesses 31 for resting on the main supports 2. The top side 32 of the longitudinal supports 3 is provided with a sawtooth-like serration 36. At the ends of the longitudinal support 3, the serration 36 is configured such that, when an adjacent longitudinal support 3 is connected at this end, the serration 36 runs continuously. In each case one depression of the serration 36 forms a mount for one of the shaped profiles 4.

The shaped profile 4 is of Z-shaped configuration. It has a plate-like central part 41, at the opposite ends of which in each case one outer part 42, 43 is arranged. The outer parts 42, 43 are arranged at right angles, and oriented in opposite directions, on the central part 41. The rear outer part 42, as seen in the conveying direction 9, is oriented obliquely upward while the front outer part 43, as seen in the conveying direction 9, is oriented obliquely downward. A transition region between the central part 41 and the outer parts 42, 43 is rounded on the inwardly oriented side 44 and is of angular configuration on the opposite, outwardly oriented side 46. The shaped profile 4 has its rear outer part 42 butting fully, and its central part 41 butting predominantly, in one of the depressions of the serration 36 of the longitudinal support 3. The front outer part 43 projects freely out of the serration 36.

The formation and the spacing of the serration 36 from one depression to the next is selected such that the shaped profile 4 has its front outer part 43 engaging in the manner of a roofing tile over the outer part 42′ of the preceding shaped profile 4′ as seen in the conveying direction. This results in a gas-throughflow channel 5 being produced between the front outer part 43 of the rear shaped profile 4 and the rear outer part 42′ of the front shaped profile 4′. With the exception of the region of its inlet 51 and of its mouth opening 52, the gas-throughflow channel 5 runs rectilinearly between the parallel outer surfaces 42′, 43. The position of the shaped profiles 4, 4′ in relation to one another is determined by the serration 36 of the main support 3. This means that all that is required is for the shaped profile 4, 4′ to be positioned in the serration 36 of the longitudinal support 3, and this readily produces the gas-throughflow channel 5 between two adjacent shaped profiles 4, 4′. The configuration of the gas-throughflow channels 5 is defined by the configuration of the serration 36 and of the shaped profiles 4. The width of the gas-throughflow channel 5 is determined by the spacing of the serration 36, on the one hand, and by the shape and thickness of the material of the outer parts 42′, 43, on the other hand. There is no need for any adjustment work. All that is thus required for assembling the cooling grate 1 is, following construction of the supports structure 2, 3, to position the shaped profiles 4 one after the other in the serration 36 of the longitudinal support 3 and to fasten them there. This produces both the supporting surface for the combustion material 8 which is to be cooled and the gas-throughflow channels 5. The cooling grate 1 thus allows a high degree of prefabrication, so that all that is then required on site is for the individual parts to be assembled. This results in a cooling grate which, on the one hand, has advantages in respect of a straightforward construction and, on the other hand, provides quality cooling gas channeling.

It should be mentioned in particular that it is not necessary, in the case of the cooling grate 1 according to the invention, for individual parts to be moved into a certain position relative to one another and then fastened permanently in this position. The relative position of the parts, in particular of the shaped profiles 4, is already defined by the configuration of the longitudinal supports 3 and cannot be changed. Assembly errors are thus largely ruled out. If the shaped profiles 4 are inserted one after the other counter to the conveying direction 9, the-operation of inserting the individual shaped profiles 4 into the serration 36 takes place particularly straightforwardly without there being any need for special introduction operations which are difficult to execute.

On account of the configuration of the shaped profiles 4, cooling gas which is directed through the gas-throughflow channels 5 passes obliquely in relation to the conveying direction, i.e. with a horizontal component parallel to the plane of the cooling grate 1, out of the cooling grate 1 and into the combustion material 8 which is to be cooled. The oblique channeling of the cooling gas combines advantages in respect of a better and, in particular, more uniform cooling action, and a reduction in the amount of material falling into and/or through the gas-throughflow channels 5. The deflections, which inhibit the amount of material falling through, are thus only necessary to a relatively small extent, as a result of which it is not just the case that the gas flow is improved; in addition, the risk of blockage is reduced.

Arranging the shaped profiles 4 transversely to the conveying direction 9 has the advantage that the cooling grate 1 subjects the combustion material 8 to a braking action. Such a braking action may be desirable in order to ensure a sufficient residence time for the combustion material in the cooler. The braking action is advantageously increased in that the outer angles 46, which project into the bed of combustion material 8, have an angular edge and are not, like the inner angles 44, rounded.

A further exemplary embodiment of the cooling grate according to the invention is illustrated in FIG. 2. Parts which correspond to the first exemplary embodiment, which is illustrated in FIG. 1, are provided with the same designations. The shaped profile 14 has flattened transition regions 144, 145 between its central part 141 and its outer parts 142, 143. The flattened transition region 144 determines the installation position of the shaped profile 14 in relation to a base, which in FIG. 2 is formed by a longitudinal support 13. By virtue of the flattened transition region 144, the shaped profile 14 is always fastened in the correct angle position in relation to the longitudinal support 13. Assembly errors in respect of the shaped profiles 14 being tilted out of their intended position are thus more or less ruled out, as is already the case with the first exemplary embodiment. The spacings between the shaped profiles 14, rather than being defined by the longitudinal support 13, can be freely selected during assembly. It is thus possible to change the width of the gas-throughflow channel in accordance with the spacing between two adjacent shaped profiles 14, 14′. Although the shaped profiles 14 are usually arranged in an equidistant manner on the longitudinal support 13, variations are possible in order for a larger or smaller stream of cooling gas to be channeled at certain locations, through a respectively wider or narrower gas-throughflow channel, to the combustion material which is to be cooled. It may thus be recommended, in regions where a high cooling capacity is required, for the shaped profiles 14 to be positioned at a relatively small spacing from one another, in order thus to achieve a larger width for the gas-throughflow channels 15. Such variations, however, are not restricted to taking account of differences in respect of the cooling capacity required; rather, they may also advantageously be used to compensate for differences in respect of the supply of cooling gas. For example, it is often the case that there is a relatively low cooling-gas pressure at those locations of the plenum 6 which are remote from the cooling-gas supply device; in order to compensate for this, the shaped profiles 14 there are arranged closer together, with the result that a larger width is provided for the gas-throughflow channels 15 and the cooling-gas feed is thus equalized over the entire cooling grate 1.

FIG. 3 illustrates a third exemplary embodiment of the cooling grate according to the invention. Parts which correspond to the first exemplary embodiment, which is illustrated in FIG. 1, are provided with the same designations. In contrast to the first exemplary embodiment, the longitudinal support 23 has a rectilinear top side 232. The shaped profiles 24 are of rounded configuration in their central part 241 and their outer part 242, 243. The angles between the outer parts 242, 243 and the central parts 241 are likewise of rounded configuration, this giving rise, overall, to more of an S-shape than a Z-shape, as was the case in the first exemplary embodiment. A gas-throughflow channel 25 is formed between the outer part 243 of a rear shaped profile 24 and the outer part 242′ of a front shaped profile 24. The gas-throughflow channel 25 itself is comparatively short and wide; it is adjoined, however, by an inlet region 251 and a mouth-opening region 252. The outer part 243 is fastened on the central part 24 so as to produce a smooth transition; the same applies to fitting the outer part 242′ on the shaped profile 24′. Although the curved configuration of the central part 24 and of the outer parts 242′, 243 and the smooth transitions between them produce a gas-throughflow channel with a double deflection, the channel is of very favourable configuration in terms of flow.

The shaped profiles according to the first, second and third exemplary embodiments are of centrally symmetrical configuration in each case.

This makes it possible to achieve a straightforward construction of the cooling grate; moreover, the risk of assembly errors due to mixed-up positioning is more or less avoided.

FIG. 4 illustrates a fourth exemplary embodiment of the cooling grate according to the invention. The shaped profiles 34 in this exemplary embodiment are not of centrally symmetrical design. They have a central part 341 which is adjoined at the front end, as seen in the conveying direction, by an outer part 343 arranged at right angles. At the rear end, as seen in the conveying direction, a hook-like outer part 342 is arranged at an obtuse angle in the central part 341. Although this embodiment no longer has the advantage of a centrally symmetrical configuration, where assembly mix-ups are prevented, it has more design freedom in respect of the configuration of the gas-throughflow channel 35. The shaped profiles 34 are usually configured in a single part, but it may ultimately remain to be seen here, as is also the case with the shaped profiles of the other exemplary embodiments, as to whether they are configured in one or more parts. The rear outer part 342 is of flat design on its bottom side and may thus be fastened on the longitudinal frame 33 without there being any need for aligning work in respect of the angle position. The spacing between the shaped profiles 34 is usually selected to be equidistant, but can be varied in order to produce gas-throughflow channels 35 of different widths.

1. A cooling grate for a bulk-material cooler, in particular for combustion material (8) such as cement clinker, of which the top side forms a carrying surface which supports the combustion material (8) which is to be cooled, the cooling grate (1) being made up of a plurality of fixed shaped profiles (4) which partially engage one over the other and between which gas-throughflow channels (5) are formed, characterized in that the shaped profiles (4) are of the same shape and have a central part (41) and outer parts (42, 43) which are angled in opposite directions to the central part (41), the shaped profiles (4) being arranged such that in each case one of the gas-throughflow channels (5) is formed between in each case one of the outer parts (42′, 43) of two directly adjacent shaped profiles (4, 4′).

2. The cooling grate as claimed in claim 1, characterized in that the outer parts (42′, 43) are arranged parallel to one another in the region of the gas-throughflow channel (5).

3. The cooling grate as claimed in claim 1 or 2, characterized in that the outer parts (42, 43) are arranged such that the gas-throughflow channel (5) formed by them provides outgoing cooling gas with a direction component parallel to the plane of the cooling grate (1).

4. The cooling grate as claimed in one of claims 1 to 3, characterized in that the shaped profile (4) is designed with rounded angles.

5. The cooling grate as claimed in one of claims 1 to 4, characterized in that the shaped profile is of Z-shaped design.

6. The cooling grate as claimed in one of claims 1 to 5, characterized in that the central part (41) and/or the outer parts (42, 43) is/are of flat design.

7. The cooling grate as claimed in one of claims 1 to 4, characterized in that the central part (241) and/or the outer parts (242, 243) is/are of curved design.

8. The cooling grate as claimed in one of claims 1 to 7, characterized in that the shaped profiles (4) are centrally symmetrical.

9. The cooling grate as claimed in one of claims 1 to 8, characterized in that the shaped profiles are arranged transversely in relation to a conveying direction (9) of the combustion material (8) which is to be cooled.

10. The cooling grate as claimed in one of claims 1 to 9, characterized in that there is provided a support (3) which has position-defining mounts (36) for the shaped profiles (4).
